(19) United States
(12) Patent Application Publication
(10) Pub. No.: US 2026/0141023 A1
(43) Pub. Date: May 21, 2026

(54) METHOD AND APPARATUS FOR PARTITIONED OPERATION OF ACTIVATION FUNCTION BY REUSING OPERATION STRUCTURE OF OUTER PRODUCT PROCESSOR

(71) Applicant: ELECTRONICS AND TELECOMMUNICATIONS RESEARCH INSTITUTE, Daejeon (KR)

(72) Inventor: Hye-Ji KIM, Daejeon (KR)

(73) Assignee: ELECTRONICS AND TELECOMMUNICATIONS RESEARCH INSTITUTE, Daejeon (KR)

(21) Appl. No.: 19/390,904

(22) Filed: Nov. 17, 2025

(30) Foreign Application Priority Data
Nov. 18, 2024 (KR) 10-2024-0164289
Nov. 3, 2025 (KR) 10-2025-0162889

(51) Int. Cl. G06F 17/16; G06F 9/30

(52) U.S. Cl. CPC G06F 17/16; G06F 9/30098

(57) ABSTRACT

Disclosed herein is a method and method for partitioned operations of an activation function by reusing an operation structure of an outer product processor. The method, performed by the apparatus, includes partitioning an activation function corresponding to a high-order polynomial into a plurality of one-dimensional linear functions, providing model parameters for the plurality of one-dimensional linear functions to a plurality of internal processing elements, and processing the plurality of one-dimensional linear functions in parallel by using a matrix multiplication result stored in a processing element (PE) register as input to each of the plurality of internal processing elements.

### CROSS REFERENCE TO RELATED APPLICATIONS

This application claims the benefit of Korean Patent Applications No. 10-2024-0164289, filed Nov. 18, 2024, and No. 10-2025-0162889, filed Nov. 3, 2025, which are hereby incorporated by reference in their entireties into this application.

### BACKGROUND OF THE INVENTION

### 1. Technical Field

The present disclosure relates generally to technology for partitioned operations of an activation function by reusing the operation structure of an outer product processor, and more particularly to an operation technique and a hardware-processing structure for processing various kinds of activation function operations in parallel by reusing an N×M matrix operation semiconductor circuit based on an outer-product processor or a vector processing AI semiconductor.

### 2. Description of the Related Art

In conventional hardware architectures for accelerating artificial neural networks, a separate dedicated processor should be provided for activation function operations. Such a dedicated processor may perform activation functions with high precision but has a limitation in the types of activation functions that can be handled thereby. Also, when various activation functions are supported, the hardware area increases, which may restrict the total number of activation function processors. For example, when an outer-product-based matrix processor finally generates N×M computational data elements and then performs activation function operations thereon, the operations are performed only on a small amount of data that does not exceed N or M data elements, according to the capacity permitted by the activation function processor.

Accordingly, there is a need for a processing method and hardware architecture capable of flexibly supporting operations for various kinds of activation functions while minimizing hardware for activation function operations. In particular, an architecture that maximizes throughput by performing activation function operations in parallel for N×M data elements output from an N×M outer-product-based matrix processor is required.

### DOCUMENTS OF RELATED ART

(Patent Document 1) Korean Patent Application Publication No. 10-2024-0129462, published on Aug. 27, 2024 and titled “Quantum matrix operator and quantum matrix operation method for artificial neural networks”.

### SUMMARY OF THE INVENTION

An object of the present disclosure is to provide activation function partitioned operation methodology and hardware architecture capable of flexibly applying various kinds of activation functions while simultaneously applying activation function operations to N×M pieces of matrix operation output data by reusing the N×M matrix processor structure of an outer-product-based AI semiconductor.

Another object of the present disclosure is to simultaneously apply activation function operations to all data generated by an outer-product-based N×M matrix processor by using only simple activation function control logic, thereby maximizing activation function throughput.

A further object of the present disclosure is to provide an activation function operation structure that is capable of flexibly applying various activation functions without adding special hardware.

Yet another object of the present disclosure is to provide technology for increasing activation function throughput that critically contributes to increases in the inference and training speed of AI semiconductors according to increasingly large next-generation neural network architectures.

In order to accomplish the above objects, a method for partitioned operations of an activation function, performed by an apparatus for partitioned operations of an activation function by reusing an operation structure of an outer product processor, according to the present disclosure includes partitioning an activation function corresponding to a high-order polynomial into a plurality of one-dimensional linear functions, providing model parameters for the plurality of one-dimensional linear functions to a plurality of internal processing elements (PEs), and processing the plurality of one-dimensional linear functions in parallel by using a matrix multiplication result stored in a processing element (PE) register as input to each of the plurality of internal PEs.

Here, the plurality of internal PEs may perform operations of the plurality of one-dimensional linear functions by reusing a Multiply and Accumulate (MAC) operation module included therein for a matrix multiplication operation.

Here, the model parameters may include a reference value for linear function selection using a breakpoint between linear functions, a slope value of a linear function, and a y-intercept value of the linear function.

Here, the plurality of internal PEs may perform operations by sequentially determining whether the matrix multiplication result is included in a region of each of the plurality of one-dimensional linear functions.

Here, when a value obtained by subtracting the matrix multiplication result from the reference value for linear function selection is greater than 0, the plurality of internal PEs determine that the matrix multiplication result is included in a region of a one-dimensional linear function located to the left of the reference value for linear function selection in a quadrant representing the plurality of one-dimensional linear functions.

Here, the plurality of internal PEs may update the matrix multiplication result stored in the PE register after performing operations for the plurality of one-dimensional linear functions.

Here, the plurality of internal PEs may include a multiplexer for selecting an input value for the MAC operation module.

Also, an apparatus for partitioned operations of an activation function according to an embodiment of the present disclosure includes an outer-product-based matrix multiplication unit including a plurality of internal processing elements (PEs); and a processor for partitioning an activation function corresponding to a high-order polynomial into a plurality of one-dimensional linear functions and providing model parameters for the plurality of one-dimensional linear functions to the plurality of internal PEs, and the plurality of internal PEs include a Multiply and Accumulate (MAC) operation module for performing a matrix multiplication operation, a processing element (PE) register for storing a matrix multiplication result, and an activation function partitioned operation controller for processing the plurality of one-dimensional linear functions by using the matrix multiplication result stored in the PE register as input to the MAC operation module.

Here, the plurality of internal PEs sequentially perform operations of the plurality of one-dimensional linear functions by reusing the MAC operation module, and the plurality of one-dimensional linear functions may be processed in parallel by the plurality of internal PEs.

Here, the model parameters may include a reference value for linear function selection using a breakpoint between linear functions, a slope value of a linear function, and a y-intercept value of the linear function.

Here, the plurality of internal PEs may perform operations by sequentially determining whether the matrix multiplication result is included in a region of each of the plurality of one-dimensional linear functions.

Here, when a value obtained by subtracting the matrix multiplication result from the reference value for linear function selection is greater than 0, the plurality of internal PEs may determine that the matrix multiplication result is included in a region of a one-dimensional linear function located to the left of the reference value for linear function selection in a quadrant representing the plurality of one-dimensional linear functions.

Here, the plurality of internal PEs may update the matrix multiplication result stored in the PE register after performing operations for the plurality of one-dimensional linear functions.

Here, the internal PEs may further include a multiplexer for selecting an input value for the MAC operation module.

### BRIEF DESCRIPTION OF THE DRAWINGS

The above and other objects, features, and advantages of the present disclosure will be more clearly understood from the following detailed description taken in conjunction with the accompanying drawings, in which:

FIG. 1 is a view illustrating an example of a conventional outer-product-based matrix multiplication unit and activation function unit;

FIG. 2 is a flowchart illustrating a method for partitioned operations of an activation function by reusing the operation structure of an outer product processor according to an embodiment of the present disclosure;

FIGS. 3 to 5 are views illustrating an example of partitioning an activation function into a plurality of one-dimensional linear functions according to an embodiment of the present disclosure;

FIG. 6 is a view illustrating an example of an instruction sequence for a pSFU operation according to the present disclosure;

FIG. 7 is a flowchart illustrating an example of an operation method of an activation function partitioned operation controller (pSFU controller) according to the present disclosure; and

FIGS. 8 and 9 are views illustrating an apparatus for partitioned operations of an activation function by reusing the operation structure of an outer product processor according to an embodiment of the present disclosure.

### DESCRIPTION OF THE PREFERRED EMBODIMENTS

The present disclosure will be described in detail below with reference to the accompanying drawings. Repeated descriptions and descriptions of known functions and configurations which have been deemed to unnecessarily obscure the gist of the present disclosure will be omitted below. The embodiments of the present disclosure are intended to fully describe the present disclosure to a person having ordinary knowledge in the art to which the present disclosure pertains. Accordingly, the shapes, sizes, etc. of components in the drawings may be exaggerated in order to make the description clearer.

In the present specification, each of expressions such as “A or B”, “at least one of A and B”, “at least one of A or B”, “A, B, or C”, “at least one of A, B, and C”, and “at least one of A, B, or C” may include any one of the items listed in the expression or all possible combinations thereof.

Hereinafter, a preferred embodiment of the present disclosure will be described in detail with reference to the accompanying drawings.

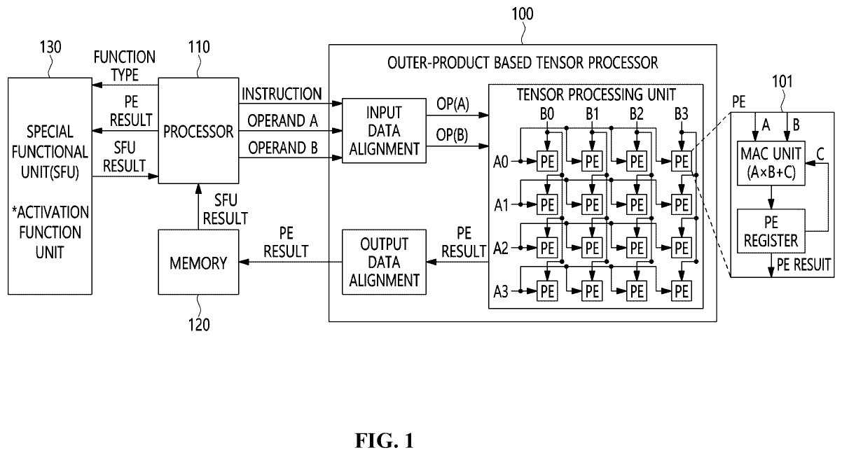

FIG. 1 is a view illustrating an example of a conventional outer-product-based matrix multiplication unit and activation function unit.

Referring to FIG. 1, the conventional outer-product-based matrix multiplication unit (outer-product-based tensor processor) 100 is equipped with a matrix processor (tensor processing unit) containing N× N Processing Elements (PEs), and the data flow from operands A and B of the matrix processor to the PEs may be as shown in FIG. 1.

Here, the operation results of the matrix processor (PE results) include N× N data elements and are stored in memory 120. Subsequently, the operation results (PE results) stored in the memory 120 may be delivered, via a processor 110, to an activation function unit (Special Functional Unit (SFU)) 130, in amounts that the activation function unit (SFU) 130 can process, and a result value acquired by applying a function corresponding to the function type may be obtained.

Here, in the structure illustrated in FIG. 1, although the matrix processor (tensor processing unit) generates N× N data elements, only data elements corresponding to the processing capacity allowed by the activation function unit (SFU) 130 are actually used for the activation function operation. Therefore, the throughput of activation function operation is inevitably limited by the number of activation function units (SFUs) 130.

Also, because only the activation function types capable of being handled by the activation function unit (SFU) 130 are processed, there is a limitation in flexibly handling various activation function types.

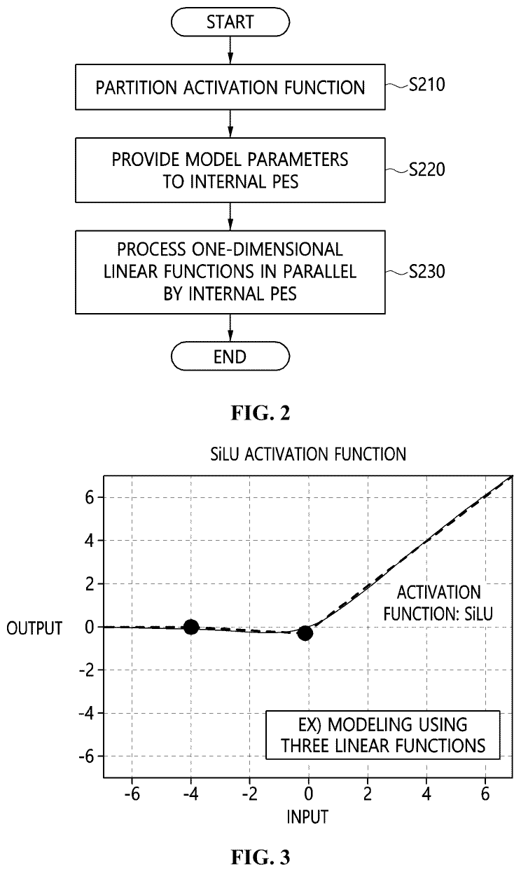

FIG. 2 is a flowchart illustrating a method for partitioned operations of an activation function by reusing the operation structure of an outer product processor according to an embodiment of the present disclosure.

Referring to FIG. 2, in the method for partitioned operations of an activation function by reusing the operation structure of an outer product processor according to an embodiment of the present disclosure, an apparatus for partitioned operations of an activation function by reusing the operation structure of an outer product processor partitions an activation function corresponding to a high-order polynomial into a plurality of one-dimensional linear functions at step S210.

Here, the activation function is partitioned into one-dimensional linear functions, whereby the operation of the activation function may be simplified into a sequence of Multiply and Accumulate (MAC) operations.

That is, the activation function defined as a high-order polynomial may be partitioned into one-dimensional linear piecewise functions such that the operation of the activation function can be performed using only a MAC operation module within a matrix multiplication unit even though the activation function unit included in the conventional structure is removed.

Such a linear piecewise modeling method may enable a single activation function model to be partitioned into numerous linear functions for modeling, and as a result, the number of parameters for the slopes and constant values of the linear functions and breakpoints between the functions may increase.

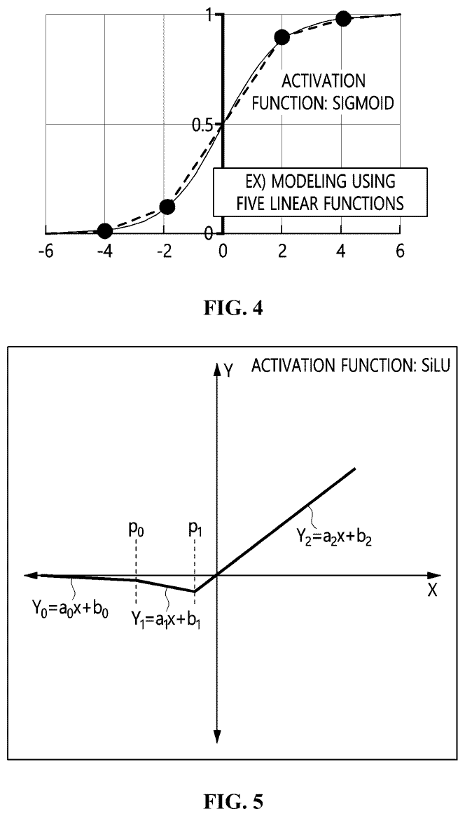

For example, FIG. 3 illustrates an example in which the Sigmoid Linear Unit (SiLU) function, which is an activation function, is modeled using three linear functions, and FIG. 4 illustrates an example in which the Sigmoid function, which is an activation function, is modeled using five linear functions.

Here, FIGS. 3 and 4 merely correspond to an embodiment for facilitating a description. Therefore, the activation function partitioned operation technique proposed in the present disclosure is not limited by the number of partitioned functions, and the hardware structure is not changed even if the number of partitioned functions increases.

Accordingly, as the number of partitioned functions increases, the computational precision of the activation function improves, but because the number of linear functions, each of which is checked per cycle, increases, the total number of operation cycles may increase.

Also, FIG. 5 illustrates an example of parameters when the SiLU function, which is an activation function, is modeled by partitioning the same into three linear functions.

Referring to FIG. 5, it can be seen that the SiLU function is partitioned into three linear functions, which are Y₀=a₀x+b₀, Y₁=a₁x+b₁, and Y₂=a₂x+b₂, using the breakpoints p₀ and p₁.

That is, because a linear function operation can be replaced with a Multiply and Accumulate (MAC: A×B+C) operation, the existing internal processing element (PE) 101 such as that illustrated in FIG. 1 may be reused.

Also, in the method for partitioned operations of an activation function by reusing the operation structure of an outer product processor according to an embodiment of the present disclosure, the apparatus for partitioned operations of an activation function by reusing the operation structure of an outer product processor provides model parameters for the plurality of one-dimensional linear functions to a plurality of internal processing elements at step S220.

Here, the model parameters may include reference values for linear function selection using the breakpoints between linear functions, the slope values of the linear functions, and the y-intercept values of the linear functions.

For example, Table 1 below illustrates the number and types of parameters that are required when an activation function is modeled by being partitioned into n one-dimensional linear functions.

TABLE 1

| pSFU Parameter | description |
|---|---|
| p₀, p₁, . . . , pₙ₋₂ | reference values for linear function selection |
| a₀, a₁, . . . , aₙ₋₂, aₙ₋₁ | slope values of linear functions |
| b₀, b₁, . . . , bₙ₋₂, bₙ₋₁ | y-intercept (bias) values of linear functions |

That is, referring to Table 1, when an activation function is partitioned into n linear functions, the breakpoints, which are reference values for selecting the respective one-dimensional linear functions, may correspond to p₀ to pₙ₋₂. Also, the slope values of the respective one-dimensional linear functions may correspond to a₀ to aₙ₋₁, and the y-intercept values thereof may correspond to b₀ to bₙ₋₁.

When this concept is applied to FIG. 5, the types and number of parameters for modeling the SiLU activation function as three one-dimensional piecewise linear functions may be illustrated as shown in Table 2.

TABLE 2

| pSFU Parameter | description |
|---|---|
| p₀, p₁ | reference values for linear function selection |
| a₀, a₁, a₂ | slope values of three linear functions |
| b₀, b₁, b₂ | y-intercept (bias) values of three linear functions |

Also, in the method for partitioned operations of an activation function by reusing the operation structure of an outer product processor according to an embodiment of the present disclosure, the apparatus for partitioned operations of an activation function by reusing the operation structure of an outer product processor processes the plurality of one-dimensional linear functions in parallel by using a matrix multiplication result stored in a processing element (PE) register as input to each of the plurality of internal processing elements at step S230.

Here, the plurality of internal processing elements may perform the operations of the plurality of one-dimensional linear functions by reusing the MAC operation modules included therein for matrix multiplication operations.

Here, the plurality of internal processing elements may perform the operations by sequentially determining whether the matrix multiplication result is included in the region of each of the plurality of one-dimensional linear functions.

For example, the internal processing elements (PEs) may store a result value computed through a previous instruction in the PE register (REG) therein. Accordingly, the piecewise SFU operation, which is the partitioned activation function operation proposed in the present disclosure, may correspond to the process of partitioning a user-desired activation function and applying the same to the value previously stored in the PE registers (REG). Here, the same activation function is applied to all of the internal PEs, but the respective PEs have different result values through the previous instructions, so it is necessary to generate respective y-values in the state in which x-values differ from each other based on FIG. 5. Accordingly, the pSFU operation may be performed by searching for the function region in which the value currently stored in the PE register is included, among the partitioned one-dimensional linear functions, and by deriving a final result by computing the y-value for the determined linear function.

Here, when the value obtained by subtracting the matrix multiplication result from the reference value for linear function selection is greater than 0, the plurality of internal PEs may determine that the matrix multiplication result is included in the region of the one-dimensional linear function located to the left of the reference value for linear function selection in a quadrant representing the plurality of one-dimensional linear functions.

Here, when the value obtained by subtracting the matrix multiplication result from the reference value for linear function selection is equal to or less than 0, the plurality of internal PEs may determine that the matrix multiplication result is not included in the region of the one-dimensional linear function located to the left of the reference value for linear function selection in the quadrant representing the plurality of one-dimensional linear functions. In this case, determination may be continuously performed using the next reference value for linear function selection.

For example, if p₀ and p₁ in FIG. 5 are −3 and −1, respectively and if the matrix multiplication result is −4, which is less than p₀, the value obtained by subtracting the matrix multiplication result from p₀ is greater than 0 ((−3)−(−4)=+1). Therefore, in this case, the matrix multiplication result may be determined to be included in the region of Y₀=a₀x+b₀, which is located to the left of p₀ in the quadrant.

In another example, if p₀ and p₁ in FIG. 5 are −3 and −1, respectively and if the matrix multiplication result is −2, which is greater than p₀ and less than p₁, the value obtained by subtracting the matrix multiplication result from p₀ is less than 0 ((−3)−(−2)=−1)). Accordingly, it can be seen that the matrix multiplication result is not included in the region of Y₀=a₀x+b₀. However, the value obtained by subtracting the matrix multiplication result from p₁ is greater than 0 ((−1)−(−2)=+1). In this case, the matrix multiplication result may be determined to be included in the region of Y₁=a₁x+b₁, which is located to the left of p₁ in the quadrant.

In a further example, if p₀ and p₁ in FIG. 5 are −3 and −1, respectively and if the matrix multiplication result is +1, which is greater than p₀ and p₁, the value obtained by subtracting the matrix multiplication result from p₀ is less than 0 ((−3)−(+1)=−4). Accordingly, it can be seen that the matrix multiplication result is not included in the region of Y₀=a₀x+b₀. Also, the value obtained by subtracting the matrix multiplication result from p₁ is also less than 0 ((−1)−(+1)=−2). Accordingly, it can be seen that the matrix multiplication result is also not included in the region of Y₁=a₁x+b₁, which is located to the left of p₁ in the quadrant. In this case, p₁ is the last reference value for determination, so the matrix multiplication result may be determined to be included in the region of Y₂=a₂x+b₂ that finally remains.

Here, the plurality of internal PEs may update the matrix multiplication result stored in the PE register after performing the operation for the plurality of one-dimensional linear functions.

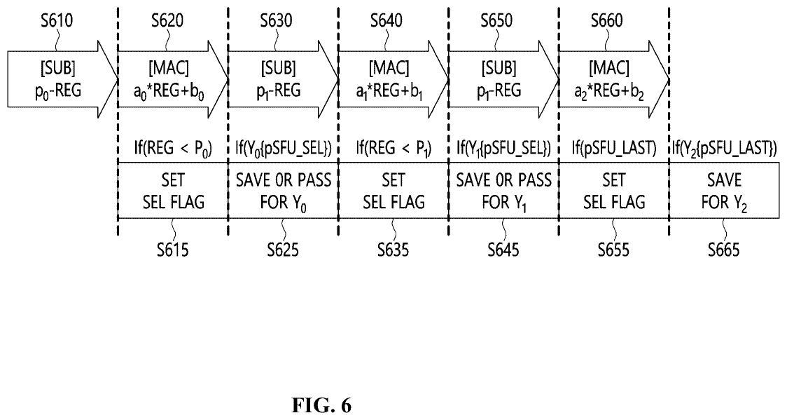

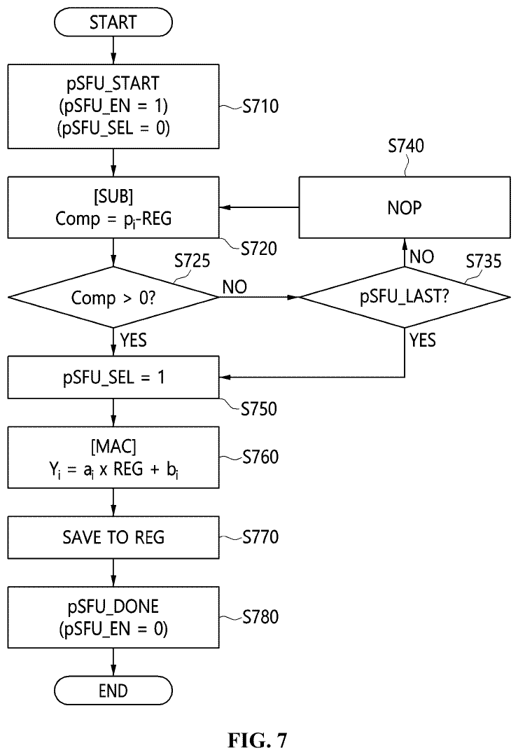

Hereinafter, the process of performing a piecewise SFU operation in all of the internal PEs for three one-dimensional linear functions will be described with reference to FIGS. 6 and 7.

Here, the pSFU operation illustrated in FIG. 6 is divided into [SUB] instruction for searching for a function and [MAC] instruction for processing the function, and all of the internal PEs may process a repeated instruction sequence of the [SUB] instruction and the [MAC] instruction in the same manner.

Here, the operation result of the [SUB] instruction for searching for a function is not used to update the PE register (PE REG) but may be used only to generate a selection signal, pSFU_SEL.

Here, the [MAC] instruction for processing the function is performed only when the value stored in the PE register (PE REG) corresponds to the region of the specific linear function that is found, thereby updating the PE register (PE REG). Accordingly, when the value stored in the PE register (PE REG) does not correspond to the region of the linear function that is currently found, the [MAC] instruction is internally processed as NOP, whereby the existing value remains in the PE register (PE REG) without updating the PE register (PE REG) with a new value.

Here, FIG. 7 illustrates a sequence of operations for sequentially searching for and processing a plurality of one-dimensional linear functions according to the present disclosure, and it may illustrate a specific operation structure of an activation function partitioned operation controller (pSFU controller) 930, which will be described with reference to FIG. 9.

Here, the model parameters illustrated in FIG. 7 will be described by applying the embodiment illustrated in FIG. 5.

Referring to FIG. 7, first, the pSFU controller may set a pSFU_EN signal to 1 and start a pSFU operation (pSFU_START) at step S710.

Subsequently, in order to check whether a matrix multiplication result currently stored in the PE register (PE REG) corresponds to the region of a function Y₀ located to the left of a reference value p₀ for linear function selection, p₀-REG operation may be performed using the [SUB] instruction at step S720. This may correspond to step S610 illustrated in FIG. 6.

Subsequently, whether the result value (Comp) of the p₀-REG operation is greater than 0 is determined at step S725, and when the result value (Comp) of the p₀-REG operation is greater than 0, which indicates that the matrix multiplication result currently stored in the PE register (PE REG) is included in the region of the function Y₀, so pSFU_SEL may be increased to 1 at step S750. This may correspond to step S615 illustrated in FIG. 6.

Subsequently, the [MAC] instruction may be performed by receiving the function parameters (slope: a₀, y-intercept: b₀) of the function Y₀ and by using the received function parameters and the matrix multiplication result currently stored in the PE register (PE REG) at step S760. This may correspond to step S620 illustrated in FIG. 6.

Subsequently, the PE register (PE REG) may be updated by storing the result of the MAC operation corresponding to a₀*REG+b₀ in the PE register (PE REG) at step S770. This may indicate that ‘SAVE for Y₀’ is performed at step S625 illustrated in FIG. 6.

Subsequently, the pSFU controller may set the pSFU_EN signal to 0, thereby completing the pSFU operation (pSFU_DONE) at step S780.

When it is determined at step S725 that the result value (Comp) of the p₀-REG operation is equal to or less than 0, which may indicate that the matrix multiplication result currently stored in the PE register (PE REG) is not included in the region of the function Y₀.

Accordingly, whether the subsequent function is Y₂, which is the last of the partitioned functions (pSFU_LAST), is checked at step S735, and when the subsequent function is not the last function, a NOP signal is generated such that one cycle of the operation according to the [MAC] instruction is skipped. This may indicate that steps S615 and S620 are skipped after performing step S610 illustrated in FIG. 6 and that ‘PASS for Y₀’ is performed at step S625.

That is, the internal processing element (PE) that does not satisfy the MAC operation condition skips the operation through NOP.

Subsequently, in order to check whether the matrix multiplication result currently stored in the PE register (PE REG) is included in the region of the next function Y₁, p₁-REG operation may be performed by using the [SUB] instruction again at step S720. This may correspond to step S630 illustrated in FIG. 6.

Subsequently, whether the result value (Comp) of the p₁-REG operation is greater than 0 is determined at step S725, and when the result value (Comp) of the p₁-REG operation is greater than 0, which indicates the matrix multiplication result currently stored in the PE register (PE REG) is included in the region of the function Y₁, so pSFU_SEL may be increased to 1 at step S750. This may correspond to step S635 illustrated in FIG. 6.

Subsequently, the [MAC] instruction may be performed by receiving the function parameters (slope: a₁, y-intercept: b₁) of the function Y₁ and by using the received function parameters and the matrix multiplication result currently stored in the PE register (PE REG) at step S760. This may correspond to step S640 illustrated in FIG. 6.

Subsequently, the PE register (PE REG) may be updated by storing the result of the MAC operation corresponding to a₁*REG+b₁ in the PE register (PE REG) at step S770. This may indicate that ‘SAVE for Y₁’ is performed at step S645 illustrated in FIG. 6.

Subsequently, the pSFU controller may set the pSFU_EN signal to 0, thereby completing the pSFU operation (pSFU_DONE) at step S780.

When it is determined at step S725 that the result value (Comp) of the p₁-REG operation is equal to or less than 0, which may indicate that the matrix multiplication result currently stored in the PE register (PE REG) is not included in the region of the function Y₁.

Accordingly, whether the subsequent function is Y₂, which is the last of the partitioned functions (pSFU_LAST), is checked at step S735.

Here, in FIG. 5, Y₂ is the last function (pSFU_LAST), and this may indicate that the matrix multiplication result currently stored in the PE register (PE REG) is included in the region of the function Y₂.

Accordingly, pSFU_SEL may be increased to 1 at step S750. This may correspond to step S655 illustrated in FIG. 6.

Subsequently, the [MAC] instruction may be performed by receiving the function parameters (slope: a₂, y-intercept: b₂) of the function Y₂ and by using the received function parameters and the matrix multiplication result currently stored in the PE register (PE REG) at step S760. This may correspond to step S660 illustrated in FIG. 6.

Subsequently, the PE register (PE REG) may be updated by storing the result of the MAC operation corresponding to a₂*REG+b₂ in the PE register (PE REG) at step S770. This may indicate that ‘SAVE for Y₂’ is performed at step S665 illustrated in FIG. 6.

Subsequently, the pSFU controller may set the pSFU_EN signal to 0, thereby completing the pSFU operation (pSFU_DONE) at step S780.

As described above, when the sequence of all instructions is finally completed, the matrix multiplication result currently stored in the PE register (PE REG) may be updated with the output value of the linear function that is mapped thereto.

Here, the total operation time in each internal PE may correspond to up to n×2 cycles, where n denotes the maximum number of partitioned functions. If the pSFU controller can detect that the PE register values of all the internal PEs are updated, the operation may be completed earlier than the time corresponding to n×2 cycles.

Here, the plurality of internal PEs may include a multiplexer for selecting an input value for the MAC operation module.

For example, the conventional internal PE 101 illustrated in FIG. 1 performs only the operation of A×B+C using the two input values, A and B, but the internal PE 900 according to the present disclosure, which is illustrated in FIG. 9, may perform the operation that additionally uses the input value C for the activation function operation.

Accordingly, the internal PE 900 according to the present disclosure may further include a multiplexer (MUX) (not illustrated) for selecting operands for the MAC unit 910 from among A, B, and C.

Through the above-described method for partitioned operations of an activation function, the activation function operation is simultaneously applied to all data generated in an outer-product-based N×M matrix processor, whereby throughput of the activation function may be maximized.

Also, the outer-product-based N×M matrix processor is reused using only simple activation function control logic, whereby the activation function operation may be performed even though a separate activation function unit is removed.

Also, technology for increasing activation function throughput, which critically contributes to increases in the inference and training speed of AI semiconductors, may be provided according to increasingly large next-generation neural network architectures.

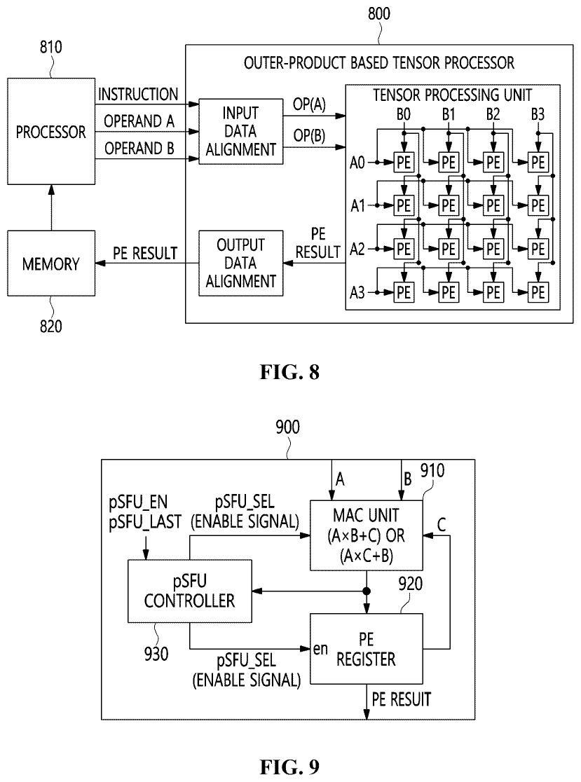

FIGS. 8 and 9 are views illustrating an apparatus for partitioned operations of an activation function by reusing the operation structure of an outer product processer according to an embodiment of the present disclosure.

First, referring to FIG. 8, the apparatus for partitioned operations of an activation function by reusing the operation structure of an outer product processer according to an embodiment of the present disclosure may include an outer-product-based matrix multiplication unit (outer-product-based tensor processor) 800, a processor 810, and memory 820.

The outer-product-based matrix multiplication unit 800 includes a plurality of internal processing elements (PEs).

The processor 810 partitions an activation function corresponding to a high-order polynomial into a plurality of one-dimensional linear functions and provides model parameters for the plurality of one-dimensional linear functions to the plurality of internal PEs.

Here, referring to FIG. 9, the plurality of internal PEs 900 may include a MAC operation module (MAC unit) 910 for performing a matrix multiplication operation, a Processing Element (PE) register 920 for storing a matrix multiplication result, and a activation function partitioned operation controller (pSFU controller) 930 for processing the plurality of one-dimensional liner functions by using the matrix multiplication result stored in the PE register as input to the MAC operation module 910.

Here, the plurality of internal PEs sequentially perform the operations of the plurality of one-dimensional linear functions by reusing the MAC operation module 910, and the plurality of one-dimensional linear functions may be processed in parallel in the plurality of internal PEs.

Here, the model parameters may include a reference value for linear function selection using a breakpoint between linear functions, a slope value of a linear function, and a Y-intercept value of the linear function.

Here, the plurality of internal PEs may perform the operations by sequentially determining whether the matrix multiplication result is included in the region of each of the plurality of one-dimensional linear functions.

Here, when a value obtained by subtracting the matrix multiplication result from the reference value for linear function selection is greater than 0, the plurality of internal PEs may determine that the matrix multiplication result is included in the region of the one-dimensional linear function located to the left of the reference value for linear function selection in a quadrant representing the plurality of one-dimensional linear functions.

Here, the multiple internal PEs may update the matrix multiplication result stored in the PE register 920 after performing the operations for the plurality of one-dimensional linear functions.

Here, the internal PEs may further include a multiplexer (not illustrated) for selecting an input value for the MAC operation module 910.

Also, the memory 820 illustrated in FIG. 8 may receive the result (PE results) obtained by applying the activation function to the matrix multiplication result from the outer-product-based matrix multiplication unit 800 and may store the same therein.

Here, specific operations of the respective components illustrated in FIGS. 8 and 9 have been described in detail with reference to FIGS. 2 to 7, so the description thereof will be omitted from the descriptions of FIGS. 8 and 9.

Using the above-described apparatus for partitioned operations of an activation function, activation function operations are simultaneously applied to all data generated by an outer-product-based N×M matrix processor, whereby activation function throughput may be maximized.

Also, the outer-product-based N×M matrix processor is reused using only simple activation function control logic, whereby the activation function operation may be performed even though a separate activation function unit is removed.

Also, technology for increasing activation function throughput, which critically contributes to increases in the inference and training speed of AI semiconductors, may be provided according to increasingly large next-generation neural network architectures.

According to the present disclosure, activation function throughput may be maximized by simultaneously applying activation function operations to all data generated by an outer-product-based N×M matrix processor.

Also, the present disclosure reuses an outer-product-based N×M matrix processor with only simple activation function control logic, thereby enabling activation function operations to be performed even though a separate activation function unit is removed.

Also, the present disclosure may provide technology for increasing activation function throughput that critically contributes to increases in the inference and training speed of AI semiconductors according to increasingly large next-generation neural network architectures.

As described above, the method and apparatus for partitioned operations of an activation function by reusing the operation structure of an outer product processor according to the present disclosure are not limitedly applied to the configurations and operations of the above-described embodiments, but all or some of the embodiments may be selectively combined and configured, so the embodiments may be modified in various ways.

What is claimed is:

1. A method for partitioned operations of an activation function, performed by an apparatus for partitioned operations of an activation function by reusing an operation structure of an outer product processor, comprising:
partitioning an activation function corresponding to a high-order polynomial into a plurality of one-dimensional linear functions;
providing model parameters for the plurality of one-dimensional linear functions to a plurality of internal processing elements (PEs); and
processing the plurality of one-dimensional linear functions in parallel by using a matrix multiplication result stored in a processing element (PE) register as input to each of the plurality of internal PEs.

2. The method of claim 1, wherein the plurality of internal PEs perform operations of the plurality of one-dimensional linear functions by reusing a Multiply and Accumulate (MAC) operation module included therein for a matrix multiplication operation.

3. The method of claim 2, wherein the model parameters include a reference value for linear function selection using a breakpoint between linear functions, a slope value of a linear function, and a y-intercept value of the linear function.

4. The method of claim 3, wherein the plurality of internal PEs perform the operations by sequentially determining whether the matrix multiplication result is included in a region of each of the plurality of one-dimensional linear functions.

5. The method of claim 4, wherein, when a value obtained by subtracting the matrix multiplication result from the reference value for linear function selection is greater than 0, the plurality of internal PEs determine that the matrix multiplication result is included in a region of a one-dimensional linear function located to left of the reference value for linear function selection in a quadrant representing the plurality of one-dimensional linear functions.

6. The method of claim 4, wherein the plurality of internal PEs update the matrix multiplication result stored in the PE register after performing the operations for the plurality of one-dimensional linear functions.

7. The method of claim 2, wherein the plurality of internal PEs include a multiplexer for selecting an input value for the MAC operation module.

8. An apparatus for partitioned operations of an activation function, comprising:
an outer-product-based matrix multiplication unit including a plurality of internal processing elements (PEs); and
a processor for partitioning an activation function corresponding to a high-order polynomial into a plurality of one-dimensional linear functions and providing model parameters for the plurality of one-dimensional linear functions to the plurality of internal PEs,
wherein the plurality of internal PEs include
a Multiply and Accumulate (MAC) operation module for performing a matrix multiplication operation,
a processing element (PE) register for storing a matrix multiplication result, and
an activation function partitioned operation controller for processing the plurality of one-dimensional linear functions by using the matrix multiplication result stored in the PE register as input to the MAC operation module.

9. The apparatus of claim 8, wherein
the plurality of internal PEs sequentially perform operations of the plurality of one-dimensional linear functions by reusing the MAC operation module, and
the plurality of one-dimensional linear functions are processed in parallel in the plurality of internal PEs.

10. The apparatus of claim 9, wherein the model parameters include a reference value for linear function selection using a breakpoint between linear functions, a slope value of a linear function, and a y-intercept value of the linear function.

11. The apparatus of claim 10, wherein the plurality of internal PEs perform the operations by sequentially determining whether the matrix multiplication result is included in a region of each of the plurality of one-dimensional linear functions.

12. The apparatus of claim 11, wherein, when a value obtained by subtracting the matrix multiplication result from the reference value for linear function selection is greater than 0, the plurality of internal PEs determine that the matrix multiplication result is included in a region of a one-dimensional linear function located to left of the reference value for linear function selection in a quadrant representing the plurality of one-dimensional linear functions.

13. The apparatus of claim 11, wherein the plurality of internal PEs update the matrix multiplication result stored in the PE register after performing the operations for the plurality of one-dimensional linear functions.

14. The apparatus of claim 9, wherein the internal PEs further include a multiplexer for selecting an input value for the MAC operation module.
